(19) United States
(12) Patent Application Publication
(10) Pub. No.: US 2020/0309577 A1
(43) Pub. Date: Oct. 1, 2020

(54) Magnetic Flowmeter with Enhanced Signal/Noise Ratio

(71) Applicant: Murray F. Feller, Micanopy, FL (US)

(72) Inventor: Murray F. Feller, Micanopy, FL (US)

(21) Appl. No.: 16/795,715

(22) Filed: Feb. 20, 2020

Related U.S. Application Data
(63) Continuation-in-part of application No. 16/367,331, filed on Mar. 28, 2019.

(51) Int. Cl. G01F 1/58

(52) U.S. Cl. CPC G01F 1/584

(57) ABSTRACT

A magnetic flowmeter has multiple pairs of electrodes spaced apart along respective lines perpendicular to both a flow direction and a magnetic field. Respective flow-induced differential voltages from each pairing of electrodes are simultaneously summed to yield a measure of a flow rate. The summing arrangement increases the output signal proportionately to the number of electrode pairs, but increases the associated composite noise output proportionately to the square root of the number of those pairs.

### RELATED APPLICATION

This application is a continuation-in-part of the inventor/applicant's U.S. Ser. No. 16/367,331 filed on Mar. 28, 2019.

### BACKGROUND OF THE INVENTION

Magnetic flowmeters sense fluid flow by detecting an electrical potential difference developed between electrodes in contact with a flowing fluid passing through a magnetic field. A typical prior art flow sensor of this type has a single pair of electrodes spanning an electrically insulating flow passage along an electrode spacing line component orthogonal to both the magnetic flux and the fluid flow direction. The magnetic field is usually reversed during a measurement interval to generate two flow signals that are combined to cancel out electrochemical potentials.

### BRIEF SUMMARY OF THE INVENTION

One aspect of the invention is that it provides a magnetic flowmeter comprising apparatus, such as an electromagnet, for producing a magnetic field perpendicular to a flow direction; a plurality of pairs of electrodes disposed so that each electrode is wetted by the flowing fluid, and wherein each pair of electrodes defines a respective electrode spacing line component lying in a measurement plane and perpendicular to both the flow direction and the magnetic field. This preferred flowmeter may comprise a preamplifier respectively associated with each electrode and having a respective output to a respective input of a differential signal amplifier respectively associated with each pair of electrodes. In this arrangement respective outputs from the differential signal amplifiers are connected to respective inputs of a summing circuit having an output representative of the rate at which the fluid flows perpendicular to the measurement plane.

A particular advantage provided by a preferred embodiment of the invention is an improvement in signal-to-noise ratio (SNR) when compared to a prior art flowmeter having a single pair of electrodes or to a flowmeter having multiple pairs of electrodes but no provision for summing the multiple outputs. The improved SNR arises because each of the individual electrode pairs produces differential electrical noise and drift related signals which are of a random nature and that differ from each other because of fluid path and electrode-fluid interface factors so that when summed, their magnitudes accumulate as the square root of the sums of their squares (RMS). However, the differentially sensed voltages from the electrodes corresponding to the fluid flow rate are directly additive. For example, when four microvolts of noise are sensed by each of two pairs of electrodes, the random nature of that noise will result in a summed noise magnitude of 5.66 microvolts. By contrast, when four microvolts of flow rate signal are sensed by each of the two pairs of electrodes in the same flow cross section and magnetic field, both have the same simultaneously generated signals with the same signal polarity so that the summed signal will be eight microvolts. By adding additional electrode pairs, the summed flow rate signal becomes larger at a faster rate than the noise signals, thereby providing an advantage in detecting the fluid flow rate. This method of increasing the flow responsive signal enables a larger signal to be obtained for the same magnetic flux. It improves the signal to noise ratio and enables the flow sensor to respond to lower flow rates and/or the same sensor performance to be achieved with a reduction in magnetic flux, thereby reducing the size, weight, cost and power consumption of the magnetic circuit components. Furthermore, because this improvement in signal to noise ratio does not require low pass filtering, the response time of the flow sensor is not increased, which is an advantage for batching applications.

Related flow sensors are described in my patents U.S. Pat. Nos. 6,431,011, 6,463,807 and 5,691,484, the disclosures of which are herein incorporated by reference.

Those skilled in the art will recognize that the foregoing broad summary description is not intended to list all of the features and advantages of the invention. Both the underlying ideas and the specific embodiments disclosed in the following Detailed Description may serve as a basis for alternate arrangements for carrying out the purposes of the present invention and such equivalent constructions are within the spirit and scope of the invention in its broadest form. Moreover, different embodiments of the invention may provide various combinations of the recited features and advantages of the invention, and that less than all of the recited features and advantages may be provided by some embodiments.

### BRIEF DESCRIPTION OF THE SEVERAL VIEWS OF THE DRAWING

FIG. 1 is a schematic cross-sectional view of a wetted portion of a prior art electromagnetic flow sensor, the section, taken perpendicular to a flow direction, defines a measurement plane.

FIG. 2 is a schematic cross-sectional view of a wetted portion of an embodiment of a flow sensor of the invention, the wetted portion comprising a second pair of electrodes and a plurality of electrode spacing lines, some of which have been omitted in the interest of clarity of presentation.

FIG. 3 is a cross-sectional view in the measurement plane of an embodiment of the invention having flow-controlling inserts providing a rectangular flow channel.

FIG. 4 is a schematic diagram of a circuit for summing inputs from multiple pairs of electrodes.

### DETAILED DESCRIPTION OF A PREFERRED EMBODIMENT

In studying this Detailed Description, the reader may be aided by noting definitions of certain words and phrases used throughout this patent document. Wherever those definitions are provided, those of ordinary skill in the art should understand that in many, if not most, instances such definitions apply both to preceding and following uses of such defined words and phrases.

As is conventional, amplifiers may be categorized by their placement in a signal processing chain. In arrangements involving two or more levels of amplification apparatus or circuitry the first level may be referred to as a preamplifier. Much of the ensuing discussion is directed at arrangements having two levels of amplification provided by components described as ‘preamplifiers’ and ‘differential amplifiers’, where the preamplifier stage may be omitted if signals are strong enough.

A differential amplifier amplifies the difference between two input voltages but suppresses any voltage common to the two inputs. It is an analog circuit with two inputs and one output in which the output is ideally proportional to the difference between the two input voltages.

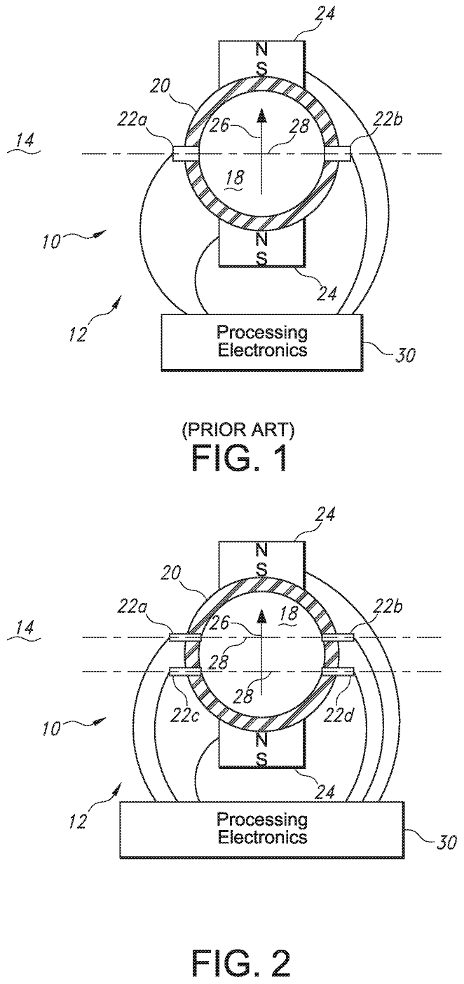

FIG. 1 is a largely schematic cross-sectional view of the sensing head portion 10 of a magnetic flow sensor 12 according to the prior art. Here the section is taken in a measurement plane 14 orthogonal to an axial flow direction. A flowing fluid 18 is contained by an electrically insulating flow tube 20 having electrodes 22a, 22b extending therethrough so as to be wetted when the fluid 18 is present. An electromagnet 24 provides a magnetic field 26 orthogonal to both the direction of flow and to an electrode spacing line 28 extending between the paired electrodes when energized during a flow sensing period.

FIG. 2 is a largely schematic cross-sectional view of the sensing head portion of a preferred embodiment of a magnetic flow meter of the invention. The depicted configuration is similar to that of FIG. 1 except for an additional pair of electrodes 22c, 22d which, like the first pair 22a, 22b, define a respective electrode spacing 28 line (shown in dot-dash phantom) that is substantially perpendicular to both the flow direction 16 and the magnetic field 26. In this embodiment the signal contributions from both pairs of electrodes 22a, 22b, and 22c, 22d are summed by the processing electronics 30 to provide a measure of the fluid flow rate.

There may be departures from this idealized sensing head geometry. The electrode spacing line may be slightly skewed with respect to the magnetic field direction. Moreover, when there are two or more pair of electrodes, there may be differences in electrode spacing lengths. One can compensate for these deviations by the known approach of multiplying the nominal length by the cosine of the angular error that is to be compensated.

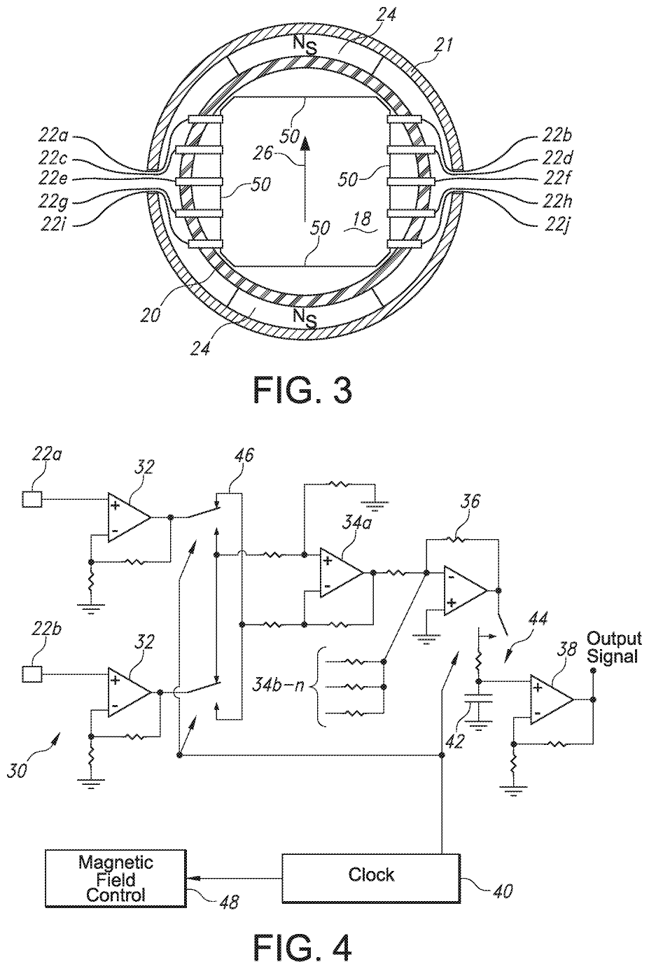

The electrodes in each electrode pair are preferably located directly across the flow path from each other. However, an electrode pair may also comprise two electrodes located diagonally across a flow path that is intersected by an orthogonal component of the magnetic flux. Although some of the drawing and discussion involves exemplar embodiments having only two pairs of electrodes, this may be done in the interest of clarity of presentation and that preferred embodiments involve a larger number of electrode pairs such as the five pair arrangement depicted in FIG. 3.

In a preferred embodiment the signals from the electrode pairs are input, as depicted in FIG. 4., either directly or through respective signal preamplifiers 32, to respective differential amplifiers 34a-34n providing respective outputs to a summing amplifier circuit 36 whose output voltage is the sum of its inputs. This arrangement provides simultaneous summing of the electrode signals. The reader will appreciate that the outputs from the differential amplifiers may also be sampled and processed with digital circuitry.

The signal from each electrode is amplified and the difference voltage between the amplified electrode signals of a pair is extracted. The extracted signals are summed by the summing amplifier 36 and, when the signal from the clock 40 is high, are transferred to the storage capacitor 42 of the low pass filter 44 from which it is fed into an output amplifier 38 to provide the flow rate output signal.

Polarity reversal in a preferred embodiment is controlled by a clock 40 that generates a rectangular wave, typically several Hz to several kilohertz in frequency, to simultaneously switch the polarity of the magnetic field by means of suitable magnetic field circuits 48 and of the paired electrodes via suitable switching circuits 46. Because the polarities of drift signals are not switched, they cancel out over the course of a switching cycle.

The number of pairs of electrodes may be increased provided that the output signals from each pair are similarly inputted to a respective differential amplifier 34a-34n having a respective output to the summing amplifier circuit 36. This will result in an output signal of greater magnitude being available for further processing to derive the fluid flow rate. For example, if each of five electrode pairs provides four microvolts of random noise, these outputs are RMS summed to a total of 8.94 microvolts. By comparison, if each of these electrode pairs provides four microvolts of flow responsive signal, these signals directly sum to twenty microvolts. Similarly, if ten electrode pairs were used, the RMS noise voltage would be 12.65 microvolts while the flow responsive signal would be forty microvolts. It becomes immediately apparent that a large number of electrode pairs will significantly improve the performance of the flow sensor as both the signal to noise ratio and the signal magnitude dramatically increase. Adding electrode pairs can therefore be more cost effective and energy efficient than increasing the magnetic flux for a given performance improvement.

Every combination of pairings of electrodes across the flow passage may be used to enhance the signal to noise ratio and the magnitude of the flow responsive signals providing that their differential noise and drift signals are of a unique and random nature and that their flow responsive signals are simultaneously additive. With the electrode signals being similarly used multiple times, a large number of electrode signals is therefore available from a relatively small number of electrodes to further enhance flow sensor performance. For example, in addition to the two electrode pairs (22a-22b and 22c-22d) indicated with the electrode spacing lines 28 in FIG. 2, one could also arrange for the signal, noise and drift voltages from the two additional pairs (22a-22d and 22b-22c) that are not shown in the figure to also contribute to the output flow signal.

Although FIG. 2 depicts a measurement section of a plastic pipe 20, the reader will recognize that one could also use an electrically insulating insert in a non-ferromagnetic metal pipe 21. Moreover, multiple inserts can be used and the spacing between the electrode pairs may be non-uniform, in which case the amplification for each electrode pair may be adjusted to compensate for volumetric measurement errors due to flow profile distortion. The degree of compensation may also be controlled as a function of the flow rate measurement as programmed for particular fluid and environmental factors, such as the operating temperature.

The configuration example of FIG. 3 shows four electrically insulating and non-ferromagnetic inserts 50 attached to the inside of a flow tube 20. The inserts are preferably tapered on the inlet and outlet of the sensor and serve to smoothly transition the flow cross section from circular to square and to provide a uniform mounting platform for the electrodes. An example of a preferable insert material is glass filled PTFE plastic as it offers good dimensional stability while providing a slippery electrically insulating surface to the fluid. The spacing between the electrode pairs may be uniform or not and/or the amplification for each electrode pair may be adjusted to compensate for volumetric measurement errors due to flow profile distortion. The degree of compensation may also be controlled as a function of the flow rate measurement as programmed for the particular fluid and environmental factors such as the actual temperature being experienced.

A further advantage of using many pairs of flow sensing electrodes polled simultaneously is the redundancy provided so that if some of the electrode pairs and associated amplifiers fail, their signal contributions could be replaced with an easily determined gain adjustment. Comparing the magnitude of the amplified flow signal from each pair of electrodes to the average contribution of the sum of the amplified signals from all of the electrode pairs or providing test signals to all of the electrode pairs and comparing their amplified outputs against factory test data, provide convenient ways of checking on the condition of an electrode pair and its amplifier(s), and determining whether servicing is required. In some applications, the calibration, repair and/or replacement intervals for meters incorporating the present invention could be on the order of several decades. The signal comparison and compensation gain adjustment can be performed manually or automatically.

Typical prior art magnetic flow sensors use constant current pulses to generate flow responsive signals. Prior to sampling differential electrode signals, a current pulse is initiated and, after the current has stabilized, a sample is taken. This process is repeated each time the flux polarity is reversed, which consumes a relatively large amount of power and is electrically noisy, thereby interfering with the detection of small flow-related electrode signals and reducing the accuracy of the sensor at low flow rates. In these prior art sensors, the electromagnet is usually a coil of copper wire that may contain a ferromagnetic core, such as soft iron, to concentrate the flux in the flow passage. Such a core retains little of the flux when the current pulse is not present. In an improved arrangement at least a portion of the core is made from a ferromagnetic material selected to have a residual portion of the magnetic flux remaining after the current pulse ends which becomes available for one or more flow measurement samples before its polarity reverses. As a result, the power consumption is greatly reduced and, because the magnet is no longer electrically energized during a selected number of electrode signal samples, the electrical noise is also reduced, thereby improving low flow accuracy. Incorporating additional pairs of sensing electrodes and summing output signals as described herein, is particularly advantageous when using magnetizable cores because the increased signal magnitude and signal to noise ratio that they provide helps compensate for the loss of signal due to the reduction in flux from the cores when the electromagnet is not electrically energized.

In an exemplar operating cycle, the electromagnet 24 is energized by an electrical pulse to magnetize its core. After a short delay to allow the electrode signal amplifiers 32, 34 to stabilize and switching noise to dissipate, the differential electrode signals are sampled, amplified and processed. When using magnetizable cores the electrical pulse applied to the electromagnet need not be a regulated current pulse of relatively long duration to provide enough time for the circuit to stabilize and its noise to dissipate before sampling. Instead, it can be a voltage pulse from the discharge of an energy storage capacitor and the sampling can take place after a delay permitting the circuit to first stabilize and its noise to dissipate. During the delay, the electromagnet circuit is not consuming any energy so that compared to the typical flow sensors which are required to maintain the full electromagnet current while awaiting electrode sampling, the operating power is reduced. Once the desired flux density has been established, as preferably monitored by a Hall effect sensor, the capacitor is disconnected and charged up to be available for pulsing the electromagnet again. After one or more such pulses, the capacitor is connected to the electromagnet with the opposite polarity so that the magnetic flux polarity is also reversed. This reversal provides long term zero drift correction.

Although a preferred embodiment uses an electromagnet to generate a magnetic field reversable in polarity, the invention is not so limited. Embodiments using permanent magnets and actuators for moving the permanent magnets to reverse the magnetic field are also possible.

Although the present invention has been described with respect to several preferred embodiments, many modifications and alterations can be made without departing from the invention. Accordingly, it is intended that all such modifications and alterations be considered as being within the spirit and scope of the invention as defined in the attached claims.

1) A magnetic flowmeter operable to determine a rate at which a fluid flows across a measurement plane substantially perpendicular to a flow direction, the flowmeter comprising:
apparatus producing a magnetic field in the measurement plane and perpendicular to the flow direction;
at least three pairs of electrodes disposed so that each electrode is wetted by the flowing fluid, when present, and wherein each pair of electrodes defines a respective electrode spacing line component lying in the measurement plane perpendicular to both the flow direction and the magnetic field; and
a respective differential signal amplifier associated with each electrode pair and having a respective input from each of the paired electrodes, wherein respective outputs from the differential signal amplifiers are connected to respective inputs of a summing circuit having an output signal representative of the rate at which the fluid flows.

2) The magnetic flowmeter of claim 1 wherein the apparatus producing the magnetic field perpendicular to the flow direction comprises an electromagnet cyclically alternating a polarity of the magnetic field.

3) The magnetic flowmeter of claim 1 further comprising a plurality of preamplifiers respectively connected between ones of the paired electrodes and the associated differential signal amplifiers.

4) A method of measuring a rate at which a fluid flows along a flow direction, the method comprising the steps of:
a) providing a plurality of pairs of electrodes, each pair defining a respective electrode spacing line component extending through the flowing fluid and disposed in a measurement plane perpendicular to the flow direction;
b) providing a single magnetic field lying in the measurement plane and perpendicular to all of the electrode spacing line components;
c) simultaneously measuring a respective differential voltage across each pair of electrodes; and
d) summing the measured voltages to generate a first output signal representative of the rate at which the fluid flows.
